(19) United States
(12) Patent Application Publication
(10) Pub. No.: US 2016/0155311 A1
(43) Pub. Date: Jun. 2, 2016

(54) ANTI-LOST ALARM METHOD AND ANTI-LOST ALARM SYSTEM

(71) Applicants: Inventec (Pudong) Technology Corporation, Shanghai (CN); INVENTEC CORPORATION, Taipei (TW)

(72) Inventor: Sheng-Fong TSAI, Taipei (TW)

(21) Appl. No.: 14/694,889

(22) Filed: Apr. 23, 2015

(30) Foreign Application Priority Data
Nov. 28, 2014 (CN) 201410707947.6

(51) Int. Cl. G08B 21/02

(52) U.S. Cl. CPC G08B 21/0269

(57) ABSTRACT

An anti-lost alarming method and an anti-lost alarm system are provided. The anti-lost alarm system includes a server and a wearable device. The wearable device produces positioning information according to a position of a wearer. According to the positioning information, the server determines whether the wearer is outside a safe region. The safe region is a geographic region defined according to previous positioning information and is where the wearer often exits. When the wearer is outside the safe region, the wearable device warns the wearer.

### CROSS-REFERENCE TO RELATED APPLICATIONS

This non-provisional application claims priority under 35 U.S.C. §119(a) on Patent Application No(s). 201410707947.6 filed in China on Nov. 28, 2014, the entire contents of which are hereby incorporated by reference.

### BACKGROUND OF THE INVENTION

1. Technical Field of the Invention

The disclosure relates to an anti-lost alarm method and an anti-lost alarm system, more particularly to an anti-lost alarm method and an anti-lost alarm system using cloud computing.

2. Description of the Related Art

In Taiwan, the proportion of the elderly population is rising year by year because of population ageing. The elderly have less memory than the middle-age and young population, especially the patients suffering from neurodegenerative diseases, e.g. Alzheimer's disease. Such diseases make the brain of a patient degenerative and make the memory of the patient lost so that the patient may easily forget the way home and go astray.

In the past, whenever such a person got lost, the family of this lost person only could ask the police office or the relative government office for help to search the lost guy. However, the search result usually felled short of the family's expectation. Therefore, it needs a system to prevent the elderly from getting lost.

### SUMMARY OF THE INVENTION

According to one or more embodiments, the disclosure provides an anti-lost alarm method applied to a wearable device. In one embodiment, the anti-lost alarm method includes the following steps. Produce positioning information according to a position of a wearer by the wearable device. According to the positioning information, determine whether the wearer is outside a safe region that is a geographic region defined according to a plurality of pieces of previous positioning information and being where the wearer often exits. When the wearer is outside the safe region, warn the wearer by the wearable device.

According to one or more embodiments, the disclosure provides an anti-lost alarm system. In one embodiment, the anti-lost alarm system includes a wearable device and a server. The wearable device produces positioning information according to a position of a wearer. The server communicates with the wearable device to receive the positioning information and defines a safe region according to a plurality of pieces of previous positioning information. The safe region is a geographic region that the wearer often exists. When the positioning information indicates that the wearer is outside the safe region, the server produces warning information. When receiving the warning information, the wearable device produces a warning signal to warn the wearer.

### BRIEF DESCRIPTION OF THE DRAWINGS

The present invention will become more fully understood from the detailed description given hereinbelow and the accompanying drawings which are given by way of illustration only and thus are not limitative of the present invention and wherein:

FIG. 1 is a block diagram of an anti-lost alarm system according to an embodiment of the disclosure;

FIG. 2 is a schematic view of a map showing a safe region and a usual route according to an embodiment of the disclosure;

FIG. 3 is a schematic view of guiding to a preset destination according to an embodiment of the disclosure;

FIG. 4 is schematic view of a map showing a separative route according to an embodiment of the disclosure; and

FIG. 5 is a flow chart of an anti-lost alarm method according to an embodiment of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

The disclosure provides an anti-lost alarm system including a wearable device to prevent the wearer of the wearable device from getting lost.

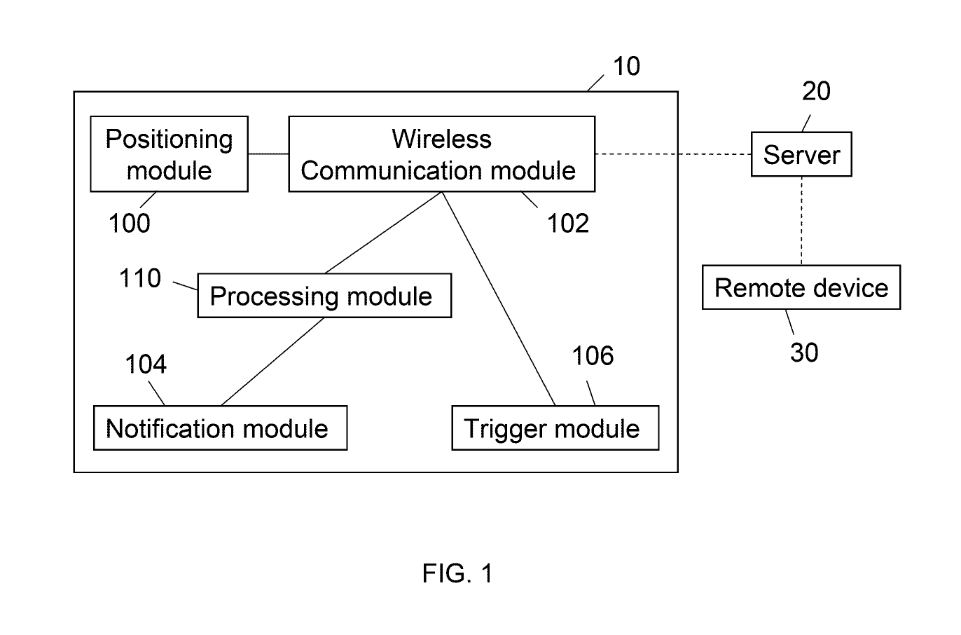

FIG. 1 is a block diagram of an anti-lost alarm system according to an embodiment of the disclosure. An anti-lost alarm system 1 includes a wearable device 10 and a server 20. The wearable device 10 communicates with the server 20. The wearable device 10 includes a processing module 110, a positioning module 100, a wireless communication module 102, and a notification module 104. The positioning module 100, the wireless communication module 102, and the notification module 104 are electrically connected to the processing module 110 such that the processing module 110 can control the operation of these modules.

In this or some embodiments, the positioning module 100 is receiver of a global positioning system (GPS) to produce positioning information according to a position of the wearer. The positioning information indicates where the wearer is. For example, the positioning module 100 can define the longitude and latitude of the position of the wearer via the GPS and use the maps in the server 20 to clearly present the position (e.g. the coordinate) of the wearer. In this or some embodiments, the wearer is an elderly person, a kid, or other people not managing self care, but the disclosure will not be limited thereto. In this or some embodiments, the processing module 110 is a micro control unit (MCU), but the disclosure will not be limited thereto.

The wireless communication module 102 communicates with the server 20 and sends the positioning information to the server 20. In this or some embodiments, the wireless communication module 102 supports the second generation (2G), third generation (3G), and/or fourth generation (4G) mobile telecommunication technology, the wireless fidelity (WiFi) technology, and/or the like. Therefore, the wearable device 10 can communicate with the server 20 anytime and anywhere. For instance, the server 20 has a computing and storage functions to store positioning information collected during a period of time and define a safe region for the wearer according to the collected positioning information. In the safe region, the wearer may go anywhere at ease.

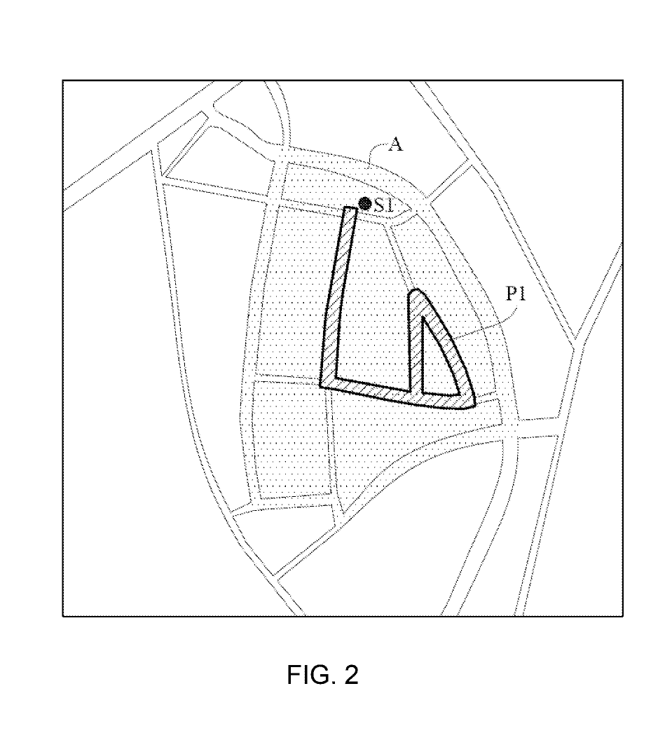

Please refer to FIG. 1 and FIG. 2. FIG. 2 is a schematic view of a map showing a safe region and a usual route according to an embodiment of the disclosure. There are a safe region A and a usual route P1 in the map. Since the positioning information indicates the position of the wearer, the server 20 can determine a union region of the wearer's tracks according to the positioning information of the wearer collected during a preset time period, to form the safe region A. The safe region A is a geographic region that the wearer often exits. On the other hand, according to such positioning information, the server 20 can count a frequency that the wearer often visited certain lands, streets, or roads, to form the usual route P1.

In an exemplary embodiment, the server 20 collects and stores all positioning information related to the wearer during one year and analyzes the collected positioning information to obtain a region (e.g. the safe region A in FIG. 2) where the wearer moves during the period of time. Furthermore, the server 20 can, according to such collected positioning information, determine that the wearer most often left a specific departure position for a specific destination to obtain a track from the specific departure position to the specific destination, e.g. the usual route P1 in FIG. 2.

In practice, the server 20 can set one year, one month or any suitable time period as a basic time unit and update the safe region A and the usual route P1 every basic time unit according to the positioning information collected in the time unit, so as to maintain the reliability of the safe region A and the usual route P1. In other words, the safe region A and the usual route P1 will change with the movement of the wearer in a time period. For example, the server 20 stores all positioning information related to the wearer during one year, determines a sub safe region corresponding to the positioning information collected every one month, and combines these sub safe regions to form the safe region A and the usual route P1. In an exemplary embodiment of updating the safe region A, when the wearable device 10 operates for one month after the year, the server 20 stores new positioning information collected in this new month by the wearable device 10 and defines a new sub safe region corresponding to the new positioning information collected in this new month. Then, the previous sub safe regions defined by the previous positioning information collected in the past eleven months and the new sub safe region are combined to form a new safe region A. Similar to the updating of the safe region A, the updating of the usual route P1 can be deduced by analogy and will not repeated hereinafter.

In addition, an optimizing algorithm can be designed by using algorithms for big data according to the wearer's living habit and the local geographic environment such that the optimizing algorithm can define an optimized safe region A in the sub safe regions corresponding to the monthly positioning information. The definition of the usual route P1 can be referred to the definition of the safe region A and will not be repeated hereinafter, and to define the safe region A according to the positioning information collected at different time and to define the usual route P1 will not be limited by the above one or more embodiments.

When the positioning information indicates that the wearer is outside the safe region A, the server 20 correspondingly produces warning information. When the wearable device 10 receives the warning information from the server 20, the notification module 104 warns the wearer in a visual and/or vocal way according to the warning information so that the wearer may realize that he or she is outside the safe region A and may get lost. For example, the notification module 104 is a smart voice module. The smart voice module plays voices by human speech according to the warning information to notify the wearer of the probability of getting lost and guide the doing of the wearer, e.g. going home or going to the closest police office or relative government office to ask for help.

On the other hand, in FIG. 1, the server 20 further communicates with a remote device 30. The wearable device 10 can send the warning information to the remote device 30 through the server 20. For instance, the remote device 30 is a smart phone or tablet computer of one family member of the wearer or a computer of one relative official in a police office or a government office. The remote device 30 notifies a preset contact person according to the warning information such that the preset contact person can know that the wearer is outside the safe region A and may get lost, and can deal with this situation.

The warning information not only commands the wearable device 10 and the remote device 30 for the warning report but also carries the positioning information (e.g. the longitude and latitude and the name of lane/street/road of the position of the wearer) of the wearer to the remote device 30 such that the preset contact person operating the remote device 30 can know the position of the wearer in real time and efficiently find out the wearer.

In this or some embodiments, the wearable device 10 further includes a trigger module 106 communicating with the processing module 110. When the processing module 110 receives the trigger signal from the trigger module 106 enabled by the wearer, the wearable device 10 acquires itinerary information from the server 20 and provides voice guide according to the itinerary information via the notification module 104. An exemplary embodiment of this case is illustrated as follows.

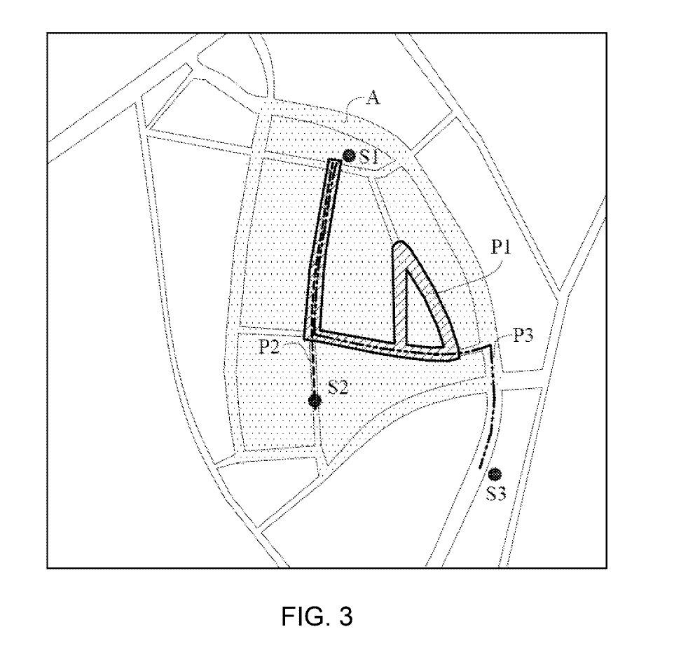

FIG. 3 is a schematic view of guiding to a preset destination according to an embodiment of the disclosure. The map in FIG. 3 shows a preset destination S1, two lost points S2 and S3, and two routes P2 and P3. When the wearer goes astray outside the safe region A or when the wearer goes astray inside the safe region A because of memory loss (referred to as memory decline), the wearable device 10 can guide the wearer to a preset destination via the notification module 104.

Specifically, in an exemplary embodiment, if the wearer gets lost at a lost point S2 in the safe region A in FIG. 3, the wearer can trigger the wearable device 10 via the trigger module 106 so that the wearable device 10 can guide the wearer to the preset destination S1 by the voice guiding of the notification module 104. For example, the preset destination S1 is the house of the wearer, a police office, or a relative government office. For instance, the trigger module 106 is a button or other trigger component for the wearer to trigger the guiding function of the wearable device 10.

Subsequently, when the wearer triggers the trigger module 106, the wearable device 10 can notify the server 20 to plan a route, e.g. a route P2, in real time so that the notification module 104 can guide the wearer to the preset destination S2 along the route. For example, the notification module 104 commands the wearer to go straight, turn left, cross a road, or the like by human voices, whereby the wearer can depart from the lost point S2 for the preset destination S1 along the route P2.

In this or some embodiments, the notification module 104 includes a displayer. By the route P2 on a map shown on the displayer or by an arrowhead sign shown on the displayer and indicating a direction in relation to the moving direction of the wearer, the wearer can visually be guided to the preset destination S1 along the route P2. For example, the displayer is a touch screen whereby the wearer can interact with the wearable device 10 through the touch screen to obtain desired information and can be protected from getting lost.

As shown in FIG. 3, the route P2 partially overlaps the usual route P1. That is, when guiding the wearer to the safe region A, the wearable device 10 further guides the wearer to the preset destination S1 along the usual route P1. Since the usual route P1 is a route that the wearer often goes along in the daily life, the wearer may recall some memory related to the usual route P1 when going along the usual route P1. Once the wearer successfully recalls the memory related to places along the usual route P1, it may be more successful for the wearer to safely arrive the preset destination S1.

When the wearer is at a lost point S3 outside the safe region A, the wearer may not know he or she has been lost. Herein, the server 20 sends the warning information to the remote device 30, and then the preset contact person operating the remote device 30 can know that the wearer may get lost and can deal with this situation. Moreover, in an embodiment, the notification module 104, according to the warning information, warns the wearer in any possible visual and/or vocal way that he or she has been outside the safe region and may get lost. In another embodiment, the notification module 104 can vocally lead the wearer to enable the trigger module 106. Therefore, the wearer can be guided to the preset destination safely along the route P3 vocal guide by such a visual and/or vocal guide. In an embodiment, the route P3 partially overlaps the usual route P1 so that the wearer arrives the preset destination S1 along the usual route P1.

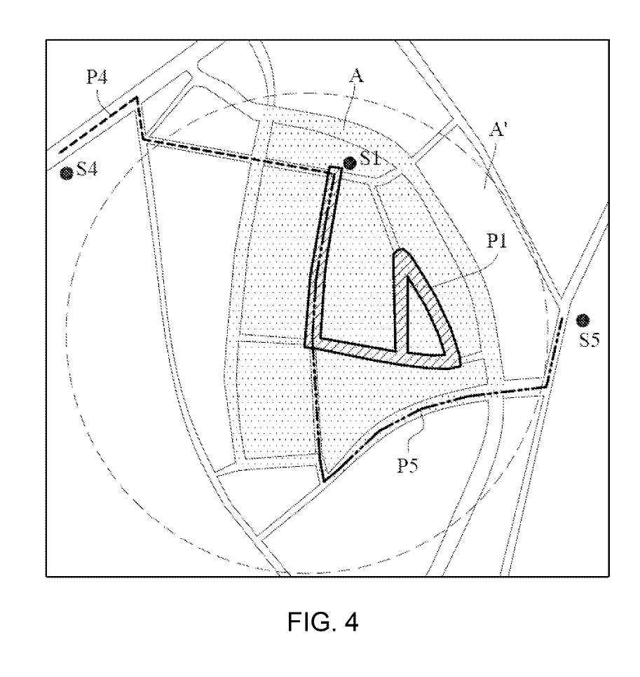

To maintain the reliability of the safe region A and the reliability of the usual route P1, when the server 20 determines that the wearer goes along a separative route far from the safe region A, the server 20 will not update the safe region A and the usual route P1 by the positioning information corresponding to the separative route. In one situation that sometimes the wearer may go to a far place with his or her family for traveling or shopping, although the wearer has left the safe region A, the wearer did not get lost. As shown in FIG. 4, a schematic view of a map showing a separative route is illustrated as follows. The map in FIG. 4 shows a safe region A, two separative points S4 and S5, and two routes P4 and P5. The region marked by a dashed-line is defined as a valid region A′. In the situation that the wearer is outside the safe region A but not lost, the server 20 considers the positioning information indicating that the wearer is inside the valid region A′ to be meaningful or valid positioning information, and then the server 20 updates the safe region A according to the meaningful or valid positioning information. Otherwise, when the wearer left the valid region A′, the server 20 considers the positioning information indicating that the wearer is outside the valid region A′, to be invalid positioning information. Therefore, no matter what the shape of the safe region A looks like, the valid region A′ includes the safe region A.

As shown in FIG. 4, the server 20 can define a valid region A′ including the safe region A according to the living habit of the wearer or the local geographic environment. When the wearer is in the safe region A, the wearer is also in the valid region A′. Herein, the server 20 determines that the positioning information is meaningful, and updates the safe region A by the positioning information. Once the wearer is outside the safe region A but still in the valid region A′, the server 20 will produce warning information for such a warning process, and such positioning information produced by the wearable device 10 will still be meaningful and valid to the server 20.

When the wearer goes to a separative point, e.g. the separative point S4 or S5, outside the valid region A′ as shown in FIG. 4, the server 20 will consider that the positioning information related to the separative point S4 or S5 is abnormal information, and the server 20 will not update the safe region A and the usual route P1 by the positioning information in order to maintain the reliability of the safe region A and the reliability of the usual route P1. Besides, the wearer can enable the wearable device 10 to obtain the guide from the wearable device 10 and leave from the separative point S4 or S5 for the preset destination S1 in the safe region A along the routes P4 and P5 of the usual route P1.

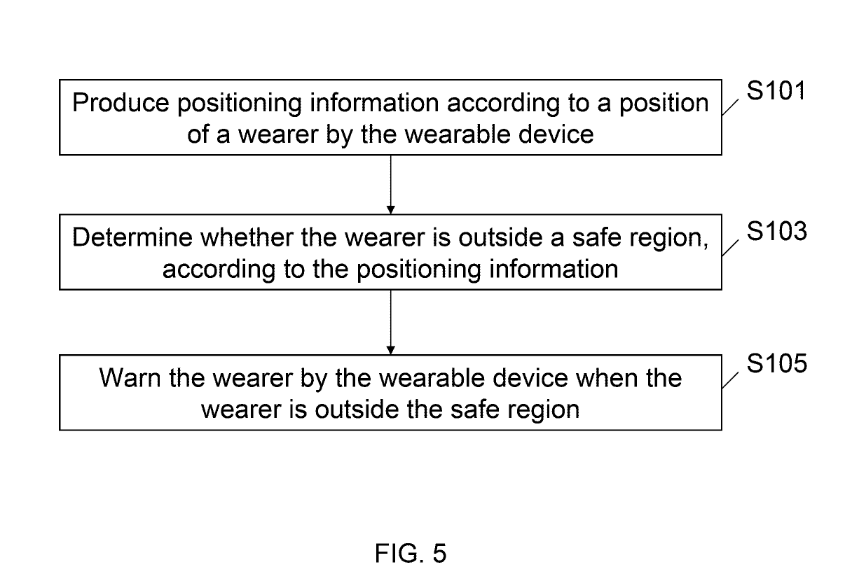

In view of the above one or more embodiments of the anti-lost alarm system, the disclosure also provides an anti-lost alarm method adapted to the above wearable device 10. FIG. 5 is a flow chart of an anti-lost alarm method according to an embodiment of the disclosure. In step S101, the wearable device 10 produces positioning information according to the position of a wearer. In step S103, according to the positioning information, determine whether the wearer is outside a safe region. The safe region is defined according to previous positioning information and is a geographic region that the wearer often goes to. In step S105, when the wearer is outside the safe region, the wearable device will warn the wearer.

As set forth above, the anti-lost alarm method and the anti-lost alarm system employ the above wearable device to positioning information related to a wearer putting on the wearable device and employ the above server with the storage and computing functions to define a safe region according to such positioning information. The server determines whether the wearer is outside the safe region, to determine whether the wearer goes astray. Moreover, the server may update the safe region once every preset time period to ensure the reliability of the safe region. When the server determines that the wearer goes astray, the wearable device will warn the wearer and try to make the wearer realize that he or she left from the safe region and may go astray and will also notify a preset contact person to correspondingly deal with this situation. On the other hand, when the wearer actively triggers the wearable device, the wearable device will guide the wearer to a preset destination in the safe region. Accordingly, it may be hard for the wearer to get lost. The disclosure may have higher practicality.

What is claimed is:

1. An anti-lost alarm method, applied to a wearable device and comprising:
producing positioning information according to a position of a wearer by the wearable device;
according to the positioning information, determining whether the wearer is outside a safe region that is a geographic region defined according to a plurality of pieces of previous positioning information and being where the wearer often exits; and
when the wearer is outside the safe region, warning the wearer by the wearable device.

2. The anti-lost alarm method according to claim 1, further comprising:
updating the safe region according to the plurality of pieces of previous positioning information every preset time period.

3. The anti-lost alarm method according to claim 1, further comprising:
according to the plurality of pieces of previous positioning information, determining a usual route that is a path in the safe region that the wearer often goes along; and
when the wearable device is triggered by the wearer, guiding the wearer to a preset destination along the usual route by the wearable device.

4. The anti-lost alarm method according to claim 1, further comprising:
when the wearer is outside the safe region, notifying a preset contact person of where the wearer is.

5. The anti-lost alarm method according to claim 1, further comprising:
according to a valid region, determining whether the positioning information is valid; and
when the positioning information indicates that the wearer is outside the valid region, considering the positioning information as an invalid positioning information and not updating the safe region by the positioning information.

6. An anti-lost alarm system, comprising:
a wearable device for producing positioning information according to a position of a wearer; and
a server for communicating with the wearable device to receive the positioning information and defining a safe region according to a plurality of pieces of previous positioning information, when the positioning information indicates that the wearer is outside the safe region, producing warning information;
wherein the safe region is a geographic region that the wearer often exists, and when receiving the warning information, the wearable device produces a warning signal to warn the wearer.

7. The anti-lost alarm system according to claim 6, wherein the server further updates the safe region according to the plurality of pieces of previous positioning information every preset time period.

8. The anti-lost alarm system according to claim 6, wherein the server further determines a usual route according to the plurality of pieces of previous positioning information, and the usual route is a path in the safe region that the wearer often goes along; and when the wearable device is triggered by the wearer, the wearable device acquires itinerary information related to the usual route from the server and guides the wearer to a preset destination along the usual route.

9. The anti-lost alarm system according to claim 6, wherein the anti-lost alarm system further comprises a remote device communicating with the server, and when producing the warning information, the server sends the warning information to the remote device, and according to the warning information, the remote device knows that the wearer is outside the safe region.

10. The anti-lost alarm system according to claim 6, wherein the server further defines a valid region for determining whether the positioning information is valid, when the positioning information indicates that the wearer is outside the valid region, the server considers the positioning information as invalid positioning information and does not update the safe region by the positioning information.
